(19) United States
(12) Patent Application Publication
(10) Pub. No.: US 2017/0193525 A1
(43) Pub. Date: Jul. 6, 2017

(54) System and Method for Detecting Counterfeit Products

(71) Applicants: Salim Shah, Vienna, VA (US); Zacharia Shah, Vienna, VA (US); Vigil Bose, Sterling, VA (US)

(72) Inventors: Salim Shah, Vienna, VA (US); Zacharia Shah, Vienna, VA (US); Vigil Bose, Sterling, VA (US)

(21) Appl. No.: 15/338,370

(22) Filed: Oct. 29, 2016

Related U.S. Application Data
(63) Continuation-in-part of application No. 14/985,857, filed on Dec. 31, 2015.

(51) Int. Cl. G06Q 30/00; G06F 17/30; G06K 7/10; H04L 29/06; G06K 19/06; G06K 7/14

(52) U.S. Cl. CPC G06Q 30/0185; G06K 19/06028; G06K 7/1413; G06K 7/10861; H04L 63/02; G06F 17/30241

(57) ABSTRACT

Systems and methods are provided for determining counterfeit products. The systems may comprise a bar code: scanner and a product database server, wherein the bar code scanner is adapted to communicate with the product database server, the product database server containing bar code data. The bar code data scanner may be included in a mobile application on a mobile device. Methods may comprise: assigning bar code data to a first product; storing the bar code data of the first product to a product database server; scanning with a mobile application bar code data of a second product in a marketplace; sending the data associated with the scanned bar code data of the second product to the product database; and determining if the bar code data of the first product in the product database server matches the scanned bar code data of the second product in the marketplace.

### FIELD OF THE INVENTION

The invention is directed to systems and methods for detecting counterfeit products. More specifically, the invention is directed to a system that allows a mobile application to communicate with a product database server to determine if the server possesses the correct product identifier (such as a barcode). The invention is also directed to a method that includes obtaining (such as by scanning) a product identifier, encrypting data associated with the obtained product identifier and sending the data to a database to determine if the database possesses the obtained product identifier.

### BACKGROUND OF THE INVENTION

Questions for any customer involved in a purchasing process may be: is this product the real thing? Is the product what the product label says it is? Is this product an original product or a knock-off copy of the original product? For most, if not all, products available on the market, there is no easy and straightforward way to determine, such as by visual inspection, if a product is genuine. The product's labeling or packaging is generally the only indication of its origins.

As is well-known, many products available on the market today may be counterfeited and sold for profit by counterfeiting parties. Depending on the type of product, a counterfeited version thereof may be prevalent in the market place. Prevalent counterfeited products may include, but are certainly not limited to, automotive parts, fashion products such as designer handbags and pharmaceuticals. In many cases, a product's labeling or packaging, along with the product, may be counterfeited.

Counterfeiting of products can be highly lucrative due to high demand and low production costs. The absence of deterrent legislation in many jurisdictions, coupled with difficulty of enforcement, also encourages counterfeiting since there is little, if any, fear of the counterfeiter being apprehended and prosecuted. Also, when prices of retail products are high, there is a greater incentive for the purchasing party to seek similar products outside the conventional retail system. Poverty, then, may play a key role in driving the demand for counterfeit products.

While purchasing a counterfeit designer handbag may be detrimental to the designer and purchasing party, such a purchase generally does not lead to adverse health effects to the designer and/or purchasing party. However, it can absolutely be envisioned that the purchase of counterfeit pharmaceuticals may lead to adverse health effects to the purchasing party, including death.

Counterfeiting is a growing global problem, particularly counterfeit products that can lead to adverse health effects. With respect to pharmaceuticals, and according to the United States FDA, counterfeit pharmaceuticals comprise more than 10% of the global pharmaceutical market and are present in both developed and developing countries. It is estimated that up to 25% of the medicines consumed in developing countries are counterfeit or substandard (Ref). Counterfeit pharmaceuticals are more prevalent in countries with: 1) weak regulation control; 2) weak enforcement; 3) scarcity and/or erratic supply of basic pharmaceuticals; 4) unregulated markets; 5) and/or unaffordable prices. One of the most counterfeited drugs today is Viagra, which is sold extensively via the Internet in industrialized countries (Ref). A World Health Organization (WHO) survey of counterfeit medicine reports from 20 countries between January 1999 and October 2000 found that 60% of counterfeit pharmaceutical cases occurred in developing countries and 40% in developed countries. A recent study in The Lancet concluded that up to 40% of artusenate products (the best medicine to combat resistant malaria today) contain no active ingredients and therefore have no therapeutic benefits (Ref).

Counterfeit pharmaceuticals may be deliberately and fraudulently mislabeled with respect to identity and/or source. This applies to both branded and generic drug products. Counterfeit pharmaceuticals may include products with the correct ingredients but fake packaging, or with the wrong ingredients, or without active ingredients or with insufficient active ingredients. In developed countries, the most frequently counterfeited pharmaceuticals are new, expensive lifestyle medicines, such as hormones, steroids and antihistamines. In developing countries, the most counterfeited medicines are those used to treat life-threatening conditions such as malaria, tuberculosis and HIV/AIDS.

Regular use of counterfeit pharmaceuticals may lead to therapeutic failure or drug resistance, and in many cases, it leads to death. For example, during the meningitis epidemic in Nigeria in 1995, over 50,000 people were inoculated with fake vaccines, received as a gift from a country, which thought they were safe. This resulted in about 2,500 deaths (Ref). In another example, the consumption of paracetamol cough syrup prepared with diethylene glycol (a toxic chemical used in antifreeze) led to 89 deaths in Haiti in 1995 and 30 infant deaths in India in 1998 (Ref). Out the approximately one million deaths that occur annually from malaria, as many as 200,000 could be avoided if the medicines available were not counterfeited.

Because of a lack of regulation and enforcement, the quality, safety and efficacy of both imported and locally manufactured pharmaceuticals in many developing countries cannot be guaranteed. Subsequently, smuggling and illegal importation of pharmaceuticals are often rife. Substandard and counterfeit pharmaceuticals are then not only sold in these countries but also exported or re-exported. The situation is exacerbated by the fact that pharmaceuticals exported from many industrialized countries are not regulated to the same level as those domestically consumed, while export of pharmaceuticals to developing countries via free trade zones is increasing. Re-labeling of products to mask details of their origin is also known to occur.

Legislation forms the basis for pharmaceutical regulation. Pharmaceuticals need to be safe and effective in order to achieve desired therapeutic effects. Ensuring the desired therapeutic effects requires the creation of competent pharmaceutical regulatory authorities with the necessary human and other resources to control the manufacture, importation, distribution and sale of genuine pharmaceutical products. However, institutional corruption and criminal activity may undermine such efforts. Government enforcement may be further undermined due to lack of intersectional cooperation between regulatory authorities, police, customs services and the judiciary, thereby diminishing an ability to effectively control the pharmaceutical market. Moreover, globalization has led to an increase in counterfeiting due in part to reduced trade barriers between countries. Furthermore, policy-makers believe that pharmaceutical regulation represents an unnecessary barrier to trade and should be reduced to a minimum. Pharmaceuticals, however, cannot be considered a standard commodity since consumers and prescribers are unable to assess their quality, safety and efficacy and the results can be harmful to a patient's health, even fatal.

There are several national and international laws and regulations specifically enacted to protect customers from counterfeited products. However, like many other laws, the enforcement of such laws and prosecution of counterfeiters is less then optimal. Moreover, in law enforcement schemes to enforce such anti-counterfeiting laws, customers are generally passive parties and may find themselves at the mercy of the enforcing agencies.

Thus, there is a need for a purchaser to quickly and accurately determine if a product is a genuine product. The systems and methods provided herein offer tools to meet such a need by empowering customers to determine directly whether a product is counterfeit or not. The systems and methods provided herein minimize the reliance on law enforcement or other entities for such a determination. The systems and methods provided herein also add social value because in certain cases (such as those related to pharmaceuticals) they can prevent death and save life.

### SUMMARY OF THE INVENTION

To overcome the aforementioned problems associated with counterfeited products, hereby is described systems and method for determining counterfeit products.

The systems may comprise: a bar code data scanner and a product database server, wherein the bar code data scanner is adapted to communicate with the product database server, the product database server containing bar code data. In embodiments, the bar code data scanner is included in a mobile application on a mobile device, the mobile application adapted for at least one of scanning bar code data, encrypting the data, sending the encrypted data to the product database server, receiving information from the product database server which indicates whether the database server contains the scanned bar code data, providing mobile device location information, providing mobile device information and providing mobile device owner information. In embodiments, the bar code data of the first product is unique bar code data and/or randomly generated bar code data.

In embodiments, systems may also include: a first network comprising an application database server that accepts requests from the mobile application and is able to decrypt the encrypted data sent by the mobile application; a first firewall allowing traffic from the internet to the first network; a second network comprising the product database server and optionally comprising a data storage database server; and a second firewall allowing traffic from the application server to the product database and/or the optional data storage database server. In embodiments, the product database server is adapted for receiving, storing, searching and sorting bar code data, receiving at least one signal from the mobile application, sending at least one signal to the mobile application, tagging the scanned bar code data as scanned, and moving the scanned bar code data to a different file.

In embodiments, the data storage database server, the data storage database adapted for receiving, storing, searching and sorting the mobile device location information, receiving, storing, searching and sorting the mobile device information and receiving, storing, searching and sorting the mobile device owner information.

In embodiments, the second firewall is adapted to separate bar code data from the mobile device information and send the bar code data to the product database server and send the mobile device information to the data storage database server.

The methods may comprise: assigning bar code data to a first product; storing the bar code data of the first product to a product database server; scanning with a mobile application bar code data of a second product in a marketplace; sending the data associated with the scanned bar code data of the second product to the product database; determining if the bar code data of the first product in the product database server matches the scanned bar code data of the second product in the marketplace. In embodiments, the methods may also include: generating the bar code data for the first product; encrypting the scanned bar code data of the second product; decrypting the scanned bar code data of the second product; and outputting a signal to the mobile application as to whether the bar code data of the first product in the product database server matches the scanned bar code data of the second product in the marketplace.

In embodiments, sending the scanned bar code data of the second product to the product database server comprises sending the data over the Internet. In embodiments, the outputting comprises binary information in the form of yes and no or in colors that correspond to yes and no.

### BRIEF DESCRIPTION OF THE FIGURES

FIG. 1 shows a schematic of a generic embodiment of the system.

FIG. 2 shows a schematic of another generic embodiment of the system.

FIG. 3 shows a schematic of an embodiment of the system for unique bar code generation.

FIG. 4 shows a representative configuration of an algorithm used for encryption of a generated bar code.

FIG. 5 shows a representative generated unique bar code.

FIG. 6 shows a representative configuration of an algorithm used for displaying a generated bar code as a GIF image.

FIG. 7 shows a schematic an embodiment of the system for verification of physical products.

FIG. 8 shows a schematic of an embodiment of the system for printing generated bar codes and labeling products therewith.

FIG. 9 shows a schematic of an embodiment of the system for modification of consumer behavior.

FIG. 10 shows a schematic of an embodiment of the system for verification of online products.

### DETAILED DESCRIPTION OF THE INVENTION

The invention now will be described more fully hereinafter with reference to the accompanying figures, in which embodiments of the invention are shown. This invention may, however, be embodied in many alternate forms and should not be construed as limited to the embodiments set forth herein.

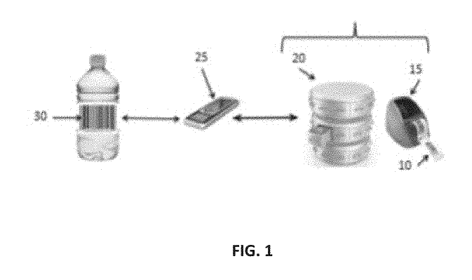

FIG. 1 shows an embodiment of a system, whereby bar code data 10 is generated and printed by generator 15. Bar code data 10 may be stored in product database server 20. Mobile device with mobile application 25 may be used to scan a product's bar code data 30 and communicate with product database server 20. Verification may be sent back to mobile application 25, whereby the user assesses the verification and decides whether or not to make the purchase.

In embodiments, the system may comprise at least one product database server 20, which is/are not particularly limited and may comprise any database server that is suitable to carry out the embodiment. The at least one product database server may be, for example, the latest Windows OS, MS SQL Server, and may be fully patched and KIDS installed. The at least one product database server may comprise the qualities of high-availability and built-in redundancy with the back-end system of the database application using client/server architecture. The back-end system performs tasks such as data analysis, storage, data manipulation, archiving, and other non-user specific tasks.

In embodiments, the system may comprise a mobile application 25 installed on a mobile device, such as a device that operates on mobile platform systems such as IOS or Android. Mobile application 25 may be written in any known language that is suitable to execute the application on a given mobile platform. The mobile application 25 should be written with proper security controls. Mobile application 25 may be distributed to mobile devices through appropriate market location and/or through appropriate media. Mobile application 25 may include other features, such as security features whereby updates may be pushed out automatically to the devices where mobile application 25 is installed. Mobile application 25 may be a signed application to verify the integrity of the written code and the provider. The mobile application 25 may be required to be activated prior to initial use, whereby a unique application activation code may be sent via short messages systems (SMS). Mobile application 25 may be adapted to scan bar code data printed on a product. Mobile application 25 may be adapted to encrypt not only the bar code data but also the basic mobile device information, such as the device's telephone number, location information in the form of coordinates and mobile device owner information such as email or residential addresses. Once encrypted, the bar code data and basic mobile device information are sent over a network to an application server (not shown) which communicates with product database server 20.

In order to maximize security of the encrypted scanned bar code data and basis mobile device information being sent, it may be desirable to send the information over the internet using WiFi so as to avoid telephone companies and other similar carriers.

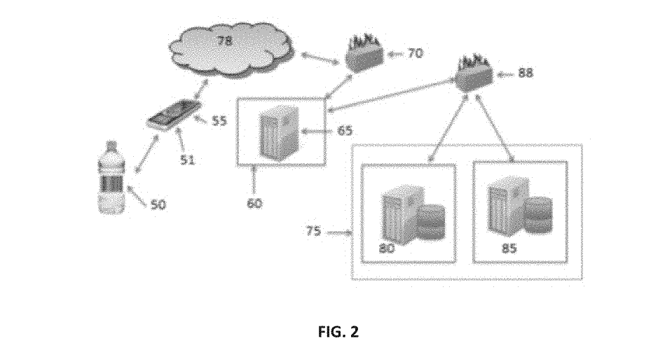

FIG. 2 shows an embodiment of a system, whereby product bar code data 50 is scanned by mobile device 51 with mobile application 55. The scanned bar code data 50 may be sent over internet 78 and transmitted to external network 60 comprising application database server 65. External network 60 may comprise a firewall 70. A query may be sent from the server 65 to internal network 75 comprising a data storage database server 80 and a product database server 85. Internal network 75 may comprise a firewall 88.

In embodiments, the system may comprise at least one application server, which is/are not particularly limited and may comprise any application server that is suitable to carry out the embodiment. The at least one application server may be, for example, the latest Windows OS, and may be fully patched and HIDS installed. The at least one application server may be a program that handles all application operations between purchaser and databases or other backend-type applications. Such an application server is typically used for complex transaction-based applications. To support these needs, the at least one application server may comprise the qualities of built-in redundancy, high-availability, high-performance distributed application services and support for complex database access.

In embodiments, the system may comprise at least one product database server 85, which is/are not particularly limited and may comprise any database server that is suitable to carry out the embodiment. The at least one product database server 85 may be, for example, the latest Windows OS, MS SQL Server, and may be fully patched and HIDS installed. The at least one product database server 85 may comprise the qualities of high-availability and built-in redundancy with the back-end system of the database application using client/server architecture. The back-end system performs tasks such as data analysis, storage, data manipulation, archiving, and other non-user specific tasks.

In embodiments, the system may comprise at least one data storage database server 80, which is/are not particularly limited and may comprise any database server that is suitable to carry out the embodiment. The at least one data storage database 80 server may be, for example, the latest Windows OS, MS SQL Server, and may be fully patched and HICKS installed. The at least one data storage database server 80 may comprise the qualities of high-availability and built-in redundancy with the back-end system of the database application using client/server architecture. The back-end system performs tasks such as data analysis, storage, data manipulation, archiving, and other non-user specific tasks.

In embodiments, the system may comprise a mobile application 55 installed on mobile device 51, such as a device that operates on mobile platform systems such as IOS or Android. Mobile application 55 may be written in any known language that is suitable to execute the application on a given mobile platform. The mobile application 55 should be written with proper security controls. Mobile application 55 may be distributed to mobile devices through appropriate market location and/or through appropriate media. Mobile application 55 may include other features, such as security features whereby updates may be pushed out automatically to the devices where mobile application 55 is installed. Mobile application 55 may be a signed application to verify the integrity of the written code and the provider. The mobile application 55 may be required to be activated prior to initial use, whereby a unique application activation code may be sent via short messages systems (SMS). Mobile application 55 may be adapted to scan bar code data printed on a product. Mobile application 55 may be adapted to encrypt not only the bar code data but also the basic mobile device information, such as the device's telephone number, location information in the form of coordinates and mobile device owner information such as email or residential addresses. Once encrypted, the encrypted scanned bar code data and basic mobile device information are sent over a network to an application server (not shown) which communicates with product database server 85.

In order to maximize security of the encrypted scanned bar code data and basic mobile device information being sent, it may be desirable to send the information over the internet using WiFi so as to avoid telephone companies and other similar carriers.

In embodiments, the system may comprise at least one security feature, which may comprise at least one firewall, encryption technology and/or anti-malware. The at least one firewall may comprise two firewalls 70, 88, wherein one firewall 70 may be disposed before the application server and the other firewall 88 may be disposed between application database server 65 and product database server 85. The encryption technology supports data encryption. This will allow for protection of purchaser and other information while the information is: 1) sent over a network, such as the Internet; 2) in rest; and 3) in use. The system may comprise anti-malware on the application and database servers to protect from unwanted software and viruses such as spyware programs.

In embodiments, the system may comprise at least one support desktop (not shown) or other type of central processing unit (not shown) to manage and maintain the application and database servers.

Application database server 65 decrypts and separates the scanned bar code data 50 and basic mobile device information, whereby the mobile device information may be sent to and stored in data storage database server 80. For marketing purposes, data storage database server 80 may be searchable and/or sortable. The decrypted bar code data may be sent to product database server 85 that contains the unique bar code data associated with each product manufactured by a given company or entity, whereby a query may be ran against product database server 85 to determine if product database server 85 contains the unique bar coded data.

In embodiments, the bar code data may be randomly generated and unique bar code data. The bar code data may be generated using an algorithm, such as a GS1 “Data Matrix” algorithm which generates two-dimensional unique and random bar code data. Such bar code data may include comprehensive information and product details. The bar code data may be generated and then stored in product database server 20, 85 and then printed and then affixed to a product. The bar code data is then printed on a label to be affixed to a product's packaging or may be printed directly on the product's packaging. Bar code data scanning software for mobile application 25, 55 for mobile devices may comprise the characteristics such as each download having associated therewith a unique number and requiring a telephone number receive an activation code for mobile application 25, 55. Such information may be transmitted to product database server 20, 85.

For example, when a genuine product is manufactured at a company's manufacturing facilities, the genuine product is assigned unique and/or random bar code data that is eventually included in the company's product database server prior to the genuine product ending up on the market. The genuine product is then sent off to the market so it can be sold to a customer. Sometime later, a customer desires to purchase the genuine product. The customer goes to the market and identifies what is believed to be the genuine product. To verify, the customer may scan the bar code data of what is believed to be the genuine product, which is sent to a product database server. The system then queries the product database server to determine if the product database server contains the unique bar code data of what believed to be the genuine product. If the scanned bar code data is present, positive verification may be sent back to customer's mobile device in the form of a SMS message. If the scanned bar code is not present, negative verification may be sent back to customer's mobile device in the form of a SMS message. The mobile application's session may be disconnected once the customer receives the positive or negative verification.

Since many users will recognize the meaning of “yes” and “no,” regardless of native language, using “yes” or “no” as the verification in binary form may be desired. Colors may also be used for verification, such as green for positive verification and red for negative verification. Since many users will recognize the meaning of “right checkmark” and “X cross mark”, regardless of native language, such verification in binary form may also be desired. Languages other than English may be used for the verification.

A customer may download mobile application 25, 55 on a mobile device. In order for mobile application 25, 55 to function, telephone number and/or email address (or other information) may be required for submission. After submission of such information, an enabling code may be sent to the mobile device via SMS to activate mobile application 25, 55. A password may or may not be required. Each application download may have unique coded information which may be collected and transmitted to a data storage database server.

Collected customer information (such as telephone number and email) may be stored in a data storage database server 80, which communicates with product database server 85, and may generate a third database automatically (not shown). Upon scanning a product's bar code data 50, the data 50 may be converted into digital information, encrypted, and pinged against product database server 85 via internet 78. The customer may receive information whether the bar code data matched with product database server 85 or not. If the bar code data is scanned less than 5 times, a green light with “Yes” may appear on mobile application 55. If the same bar code data is pinged more than 5 times, the customer may receive a notice or “warning” with a yellow color. If the same bar code data is pinged more than 10 times, a red light may appear with “No”. If the bar code data is scanned more than 10 times just “by checkers” and the product was not sold, the seller will have an option to send a message to reset according to a particular product (once or twice). When a customer scans a product's bar code data, two queries will be sent out in parallel, the product information with unique application download information number may be sent to application server 60 and the product information will be pinged against product database server 85.

The embodiments described herein are also useful in applications other than counterfeit detection and consumer information, such as in law enforcement and consumer behavior.

If the embodiments described herein detect counterfeit products, the location of the counterfeit products may be obtained by modification of the embodiments to include tracking features. Such tracking features may include longitude and latitude coordinates (via GPS) at the time of scanning a desired product. The law enforcement community may be interested in knowing the origin or location of the point of sale for desired products determined to be counterfeit. Moreover, the commerce community may be interested in statistics related to the origin or location of the point of sale for desired products determined to be counterfeit.

The embodiments described herein may be modified for consumer behavior purposes. For instance, once a desired product is scanned using the embodiments described herein, a coupon may be sent to the consumer's device to influence decision making. The offer of an instant discount or reduction in price in real-time may spur a consumer to purchase a desired product. Also, offers may be sent to a consumer's device that are related to a scanned product. In other words, if a consumer scans product that is a handbag, an offer of an instant discount or reduction in price for a corresponding wallet (that goes with the handbag) may be sent to the consumer's device.

The advertising community may also be interested in the collected customer information (such as telephone number and email). For instance, the aforementioned third database (not shown, generated by communication between data storage database server 80 and product database server 85) may include customer information for customers who purchased, for example, handbags. Advertisements may then be sent to the consumer's device for handbags and related accessories.

### Random Unique Barcode Generation Flow

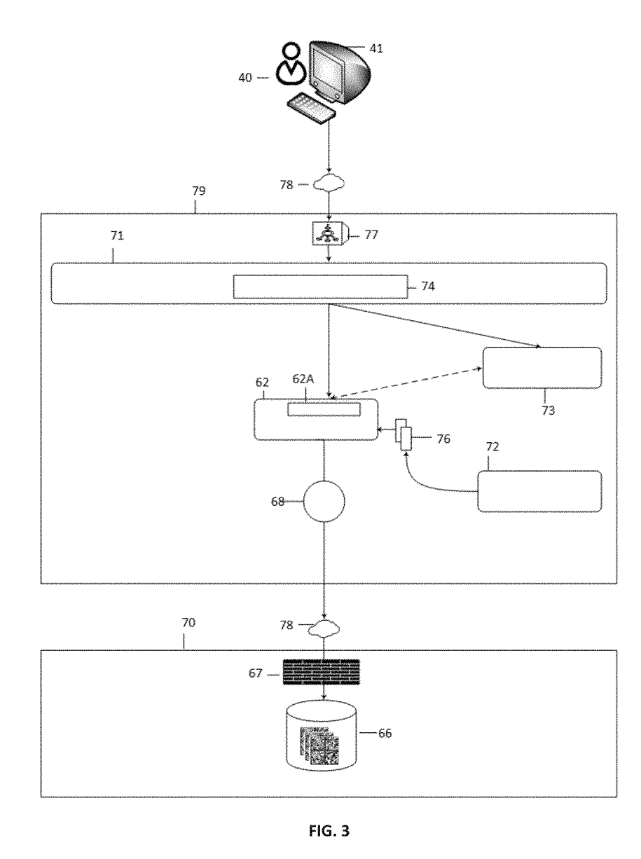

FIG. 3 shows an embodiment of a system, whereby a user 40 can enter product information using their local computer system 41. The product information is then sent over internet 78 using Hyper Text Transfer Protocol (HTTP) via an encrypted channel with Secure Sockets Layer Protocol 3.0 (SSL) to an external network 79. The user 40 who can generate barcode using product information is usually an authorized personnel from the manufacturer.

In embodiments, the external network 79 may comprise one or more instances of gateway server 71 that processes intelligent routing of Application Programming Interface (API) request. The gateway server may also handle user authentication using OAUTH2 protocol. The gateway server 71, with the help of one or more discovery server instances 73, routes barcode generation API requests to one or more instances of barcode service 62. The OAUTH2 protocol specification is available at https://tools.ietf.org/html/draft-ietf-oath-v2-31. OAUTH2 is used as an authorization framework that enables applications to obtain limited access to user accounts on an HI IP enabled service, such as LinkedIn, Facebook, GitHub, and our own ASCTHEM. It works by delegating user authentication to the service that hosts the user account, and authorizing third-party applications to access the user account. OAUTH2 provides authorization flows for web and desktop applications, and mobile devices.

The external network 79 may also comprise one or more instances of a configuration server that supplies environment (development, staging or production) specific property values 76 to the barcode service 62 that request for environment specific property. The barcode service 62 is also a discovery client 62A that gets automatically discovered by the service registration and discovery server 73. The barcode service 62 further sends the generated barcode data request via external message gateway 68 to a manufacturer's network via internet 78 to store it in a product database 66 that is installed behind a firewall 67. The product database 66 is also used for matching of barcode data when the user 40 scans a particular product barcode.

The user 40 (manufacturer authorized personnel) can also query for a particular product barcode data 50 from product database 66. The user 40 can also request for a batch of product barcodes for printing labels on a tangible surface.

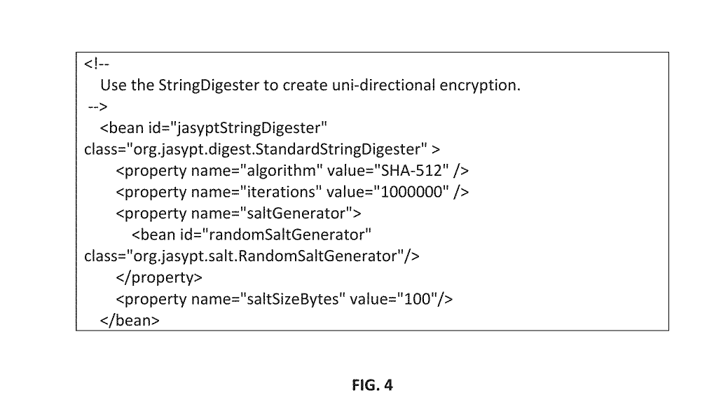

In embodiments, the system uses a combination of one-way hash digest, SHA-512 and salt algorithms to apply encryption technology to encrypt the generated barcode data before it gets stored in product database 66. An example configuration of encryption algorithm using a third party library called JASYPT is shown in FIG. 4.

In embodiments, the barcode data is randomly and uniquely generated. The barcode data can be generated using any existing standard algorithm such as GS1 “Data Matrix” algorithm, which generates two-dimensionally unique and random barcode data 50. The barcode generator uses a combination of Global Trade Item Number, Batch or Lot number, Packaging Month, Expiration Month, and Country of Origin to come p with a Serial Number and an Additional Random Alpha Numeric Identification Number. Table 1 shows such a GS1 Data Matrix.

TABLE 1
GS1 Data Matrix

| | GS1 | | | | | | | Identifier |
|---|---|---|---|---|---|---|---|---|
| | Specification | Application | Max | | Encoding | | | (s) in the |
| # | Element | Identifier | Length | Type | Order | Sample Data Encoding | Sample Element Encoding | system |
| 1 | Global Trade | 01 | 14 | Fixed | 1 | 00000169706515 | (01)00000169706515 | YES |
| | Item Number | | | | | | | |
| 2 | Batch or Lot | 13 | 20 | Variable | 2 | LOT000001697065150003 | (13) LOT000001697065150003 | |
| | Number | | | | | | | |
| 3 | Packaging | 17 | 6 | Fixed | 3 | 11 | (17)11 | |
| | Month | | | | | | | |
| 4 | Expiration | 10 | 6 | Fixed | 4 | 11 | (10)11 | |
| | Month | | | | | | | |
| 5 | Serial Number | 21 | 20 | Variable | 5 | M42HKLEBN035GA1DJFIC | (21) M42HKLEBN035GA1DJFIC | YES |
| 6 | Additional item | 240 | 30 | Variable | 6 | PLHDBJ7GKF8QES39NOC041 | 240 | YES |
| | Identification | | | | | 5T0R2AIM | PLHDBJ7GKF8QES39NOC0415T | |
| | | | | | | | 0R2AIM | |

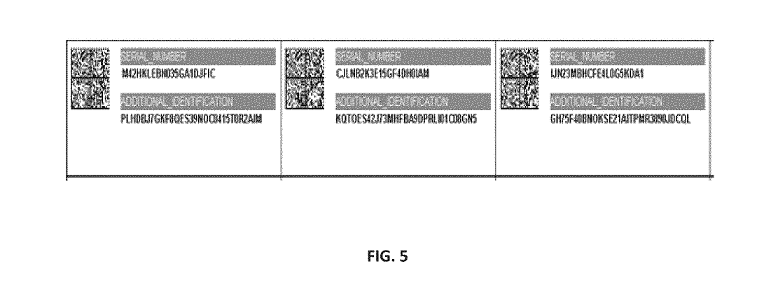

The aforementioned Serial Number and Additional Random Alpha Numeric Identification Number together becomes a very large unique number and is a part of the generated barcode for each label or package, as shown in FIG. 5.

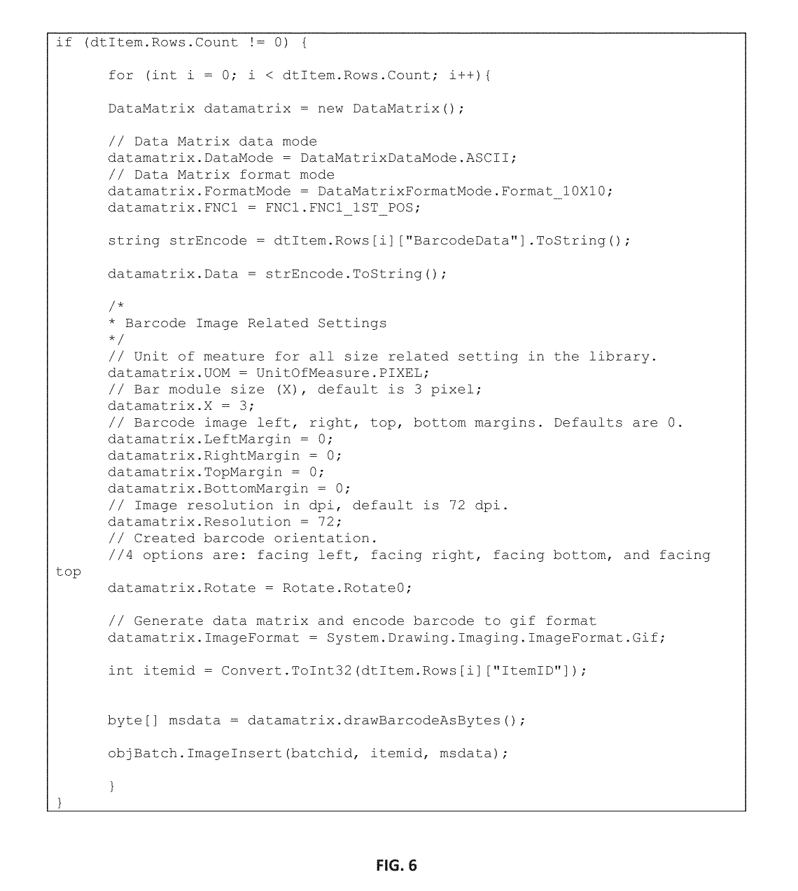

The barcode data 50 that comprises comprehensive product information is stored in product database 66. This barcode data is used for further querying and printing labels on a tangible surface to affix to a product directly or indirectly. This barcode data 50 can also be printed on a product packaging. The barcode may also be displayed as a GIF image and the algorithm used for such a GIF display is shown in FIG. 6. Barcode data scanning software for mobile application 55 for mobile devices comprise the characteristics such as each download having associated with a unique number and an authentication means to receive an activation code for the mobile application 55.

### Product Verification Flow

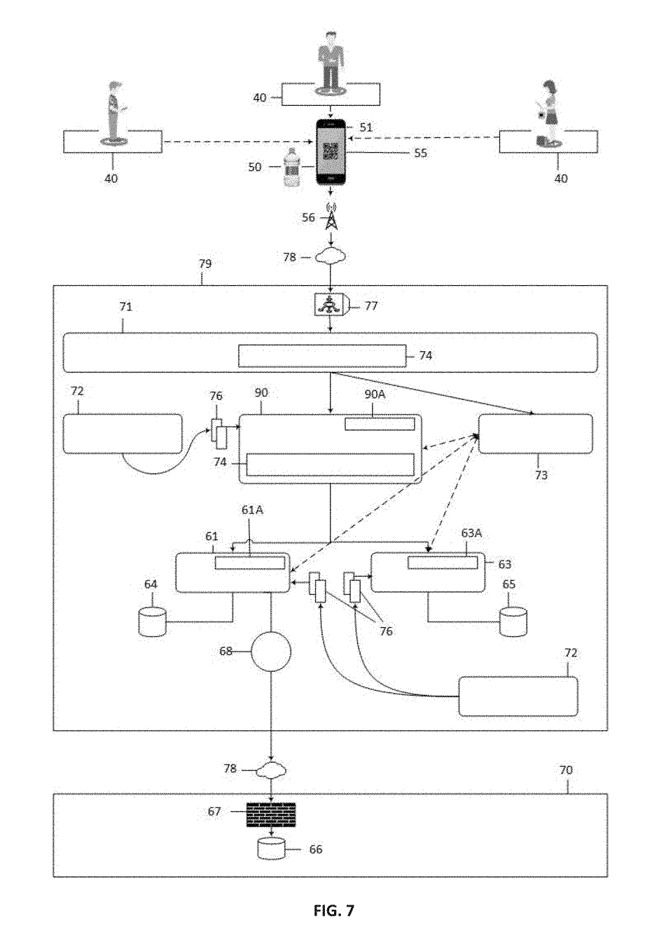

FIG. 7 shows an embodiment of a system, whereby a user 40 can scan a physical product barcode data 50 using a mobile device 51 loaded with a mobile scanning application 55. The scanned barcode data 50 may be sent over Internet 78 via telecommunication (Telco) gateway 56 using hypertext transport protocol (HTTP) over encrypted channel using secured sockets layer 3.0 and transmitted to external network 79. This external network 79 comprises a load balancer 77. External network 79 may also comprise one or more instances of a gateway server 71 that processes intelligent routing. The gateway server 71 may also have a capability to authenticate the incoming request via a protocol such as OAUTH2. A typical user who does product verification is a customer who likes to verify the genuineness of the product that they are buying.

In embodiments, the product verification request coming from public Internet 78 reaches the load balancer 77 in the external network 79. The request is the sent to the gateway server 71. The external network 79 may also comprise a service registration and discovery server 73. This registration and discovery server 73 keeps track of all internal software services installed within the external network 79.

The gateway server 71 may use service registration and discovery server 73 to intelligently route HTTP requests using a client side load balancer 74 by dynamically identifying the application server port and the server hostname Internet protocol (IP) address or a Dynamic Name Service (DNS) name of the server where application service (for example verification composite service 90) is installed and running within the external network 79.

In embodiments, the system may comprise one or more instances of each software service to carry out the embodiment. Each software service available in the system landscape may be virtualized using container based technology such that there will not be any port conflicts between different instances of application server running within the same server host. With all application service instances become available and registered with the discovery server, the gateway server 71 can intelligently route API requests at scale on demand basis using client side load balancer 74 to the appropriate application service, for example verification composite service 90.

In embodiments, the system may comprise one or more instances of verification composite service 90. This verification composite service 90 upon receiving request from gateway server 71 and with the information available from the discovery server 73, sends the request to one or more instances of verification service 61 and the app user service 63 respectively. The verification composite service 90 is also a discovery client 90A that gets automatically discovered by the service registration and discovery server 73.

In embodiments, the system may comprise at least one database 64 to store detected counterfeit product information and its geographic locations. When the user scans a product barcode data 50, the verification service 61 sends out a search query to the manufacturer network via external message gateway 68. The query request is then sent via public Internet 78 to the manufacturer product database 66 via a firewall 67 for matching the scanned product's unique barcode information. If a match is found, the verification service 61 will receive product match information from manufacturer product database 66 which gets sent back to the customer mobile device 51 and the information gets displayed as a green check mark on the mobile scanning app 55 user interface.

The user with the product match information available on their mobile device, can then decide whether to purchase an authentic product or not.

If there is no match available for the requested product for verification, the verification service sends back the results of the match to the user's mobile device as a red check mark to indicate it as a potential counterfeited product. At this point, the customer can decide whether to walk away from buying a potential counterfeited product or not. The verification service also records the potential counterfeited product info in the counterfeit database 64.

If the embodiments described herein detect counterfeit products, the location of the counterfeit products may be obtained by modification of the embodiments to include tracking features. Such tracking features may include longitude and latitude coordinates via Global Positioning System (GPS) at the time of scanning a desired product. Various organizations, governmental or non-governmental, may be interested in knowing the origin or the point of sale location of the counterfeit product. The counterfeit information is stored in counterfeit database 64. This information can then be utilized by the product manufacturer for curbing the availability of counterfeited products in the market. By curbing the availability of counterfeited products, the manufacturer will ultimately benefit them financially and help preserve their brand image.

In embodiments, the system may comprise at least one app user database server 65 to house the customer information. When the scanned product data 50 is sent to verification composite service 90, the app user specific information such as product scan location is also captured in app user database 65 through app user service 63. The verification composite service 90 makes use of available client side load balancing facility to send out search request to verification service 61 as well as sends out app user information to update app user database 65.

The at least one user database 65 running on Linux, UNIX or Windows OS, MS SQL Server and may be fully patched with security updates. The at least one app user database server 65 may comprise the qualities of high-availability and built-in redundancy. This information available in app user database may be used to perform tasks such as data analysis, storage, data manipulation, archiving and other marketing related tasks.

In embodiments, the system decrypts and separates the scanned barcode data 50 and user specific information, whereby the user information may be sent to app user service 63 and gets stored in user database 65. The user database 65 is a searchable and/or sortable database. The decrypted barcode data may be sent to product database 66 over an encrypted internet channel using HI IP and SSL 3.0 protocol via external message gateway 68 to the manufacturer's network. The product database 66 contain the unique random barcode data (for example GS1 compliant) associated with each product manufactured by a given company or entity, whereby a query may be run via verification service 61 against product database 66 to determine if product database 66 contains the unique barcode data.

In embodiments, the system may also comprise one or more instances of a configuration server 72. The configuration server will supply environment (example: development, staging or production) specific property values 76 to the appropriate application service that request for such properties. This environment specific properties 76 may be available as name value pairs (example: application.service.name=Verification Service) in any commercially or open source available version control software (not shown).

### Validation Process

The validation of a product involves three steps. First step is the identification of the company to which the product belongs to by using the Global Trade Item Number (GTIN). If this identification is successful, then the system validates the serial number issued with the GTIN in the barcode. Thirdly, an additional ID will be validated if one is issued against the serial number that the system just validated. If all the levels are successful then the product is marked as genuine during verification. The combination of GTIN, Serial No, Additional ID validations will make the barcode data unique in the system and is difficult to crack. Serial Number and Additional ID are unique for a product manufacturer.

### Random Unique Barcode Printing and Labeling Flow

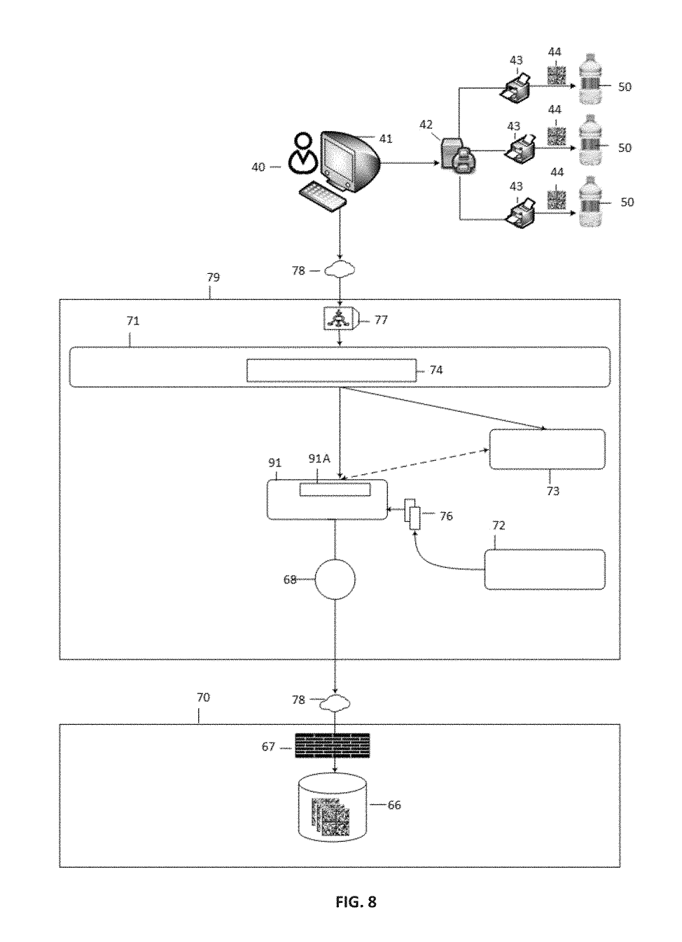

FIG. 8 shows an embodiment of a system, whereby a user 40 can request for a batch of product barcodes for printing and labelling. The user 40 issues a search request based on product identifier over Internet 78 using HTTP via encrypted channel with Secure Sockets Protocol 3.0 to external network 79. The user 40 who typically request for a batch of product barcodes for printing and labelling is a manufacturer authorized personnel.

In embodiments, the external network 79 may comprise one or more instances of gateway server 71 where intelligent routing of API request happens. This layer may also handle user authentication. The gateway server 71, with the help of one or more discovery server instances 73, routes barcode finder API request to one or more instances of barcode finder service 91.

The external network 79 may also comprise a load balancer, one or more instances of a configuration server that supplies environment (development, staging or production) specific property values 76 to the barcode finder service 91 that request for environment specific properties. This environment specific properties 76 may be available as name value pairs (application.service.name=Barcode Finder Service) in any commercially or open source available version control software (not shown).

The barcode finder service 91 further sends the search request via external message gateway 68 to the manufacturer network via internet 78 to retrieve a batch of product barcodes from the product database 66 that is installed and functioning behind a firewall 67. The database 66 is also used for matching of barcode data when the customer 40 scans a particular product barcode using mobile device 51 with a mobile application 55 (See FIG. 7). The barcode finder service 91 is also a discovery client 91A that gets automatically discovered by the service registration and discovery server 73.

Once the user 40 successfully retrieves a batch of product barcodes over internet 78 using HTTP secured with Secure Sockets Layers (SSL 3.0) protocol into a computer 41, the user 40 can further initiate another API request to perform printing of labels. The opportunities available to the user 40 to save random unique barcodes in a digital format are advantageous. The user 40 can issue a print command to a print server 42 that is available on a network. This print server may be connected to one or more printers that can print random unique product barcode labels and can directly or indirectly be affixed on a product 50.

### Customer Behavior Modification Via Discount Coupons Flow

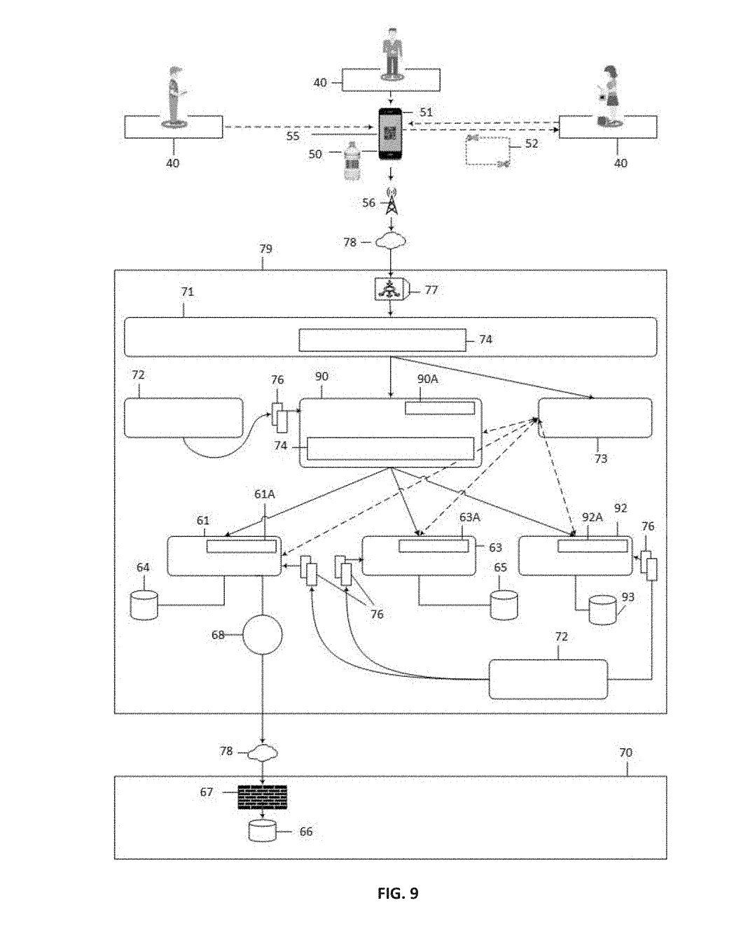

FIG. 9 shows an embodiment of a system that may help change customer's buying behavior at a point-of-sale. The user 40, who is interested in verifying the authenticity of the product can user a mobile device loaded with the mobile scanning application 55 to scan the barcode data 50 from displayed on the product. The scanned barcode data 50 may be sent over internet 78 via telecommunication gateway 56 using hypertext transport protocol (HTTP) over an encrypted channel using secured sockets layer 3.0 and transmitted to external network 79 that comprises a load balancer 77. External network 79 may also comprise one more instances of a gateway server 71. This gateway server 71 may also have a capability to authenticate the incoming request via a standard protocol such as OAUTH2.

The external network 79 may also comprise a service registration and discovery server 73. This registration and discovery server 73 keeps track of all internal software services installed within the external network 79. The gateway server 71 may use service registration and discovery server 73 to identify the application server port and the server hostname internet protocol (IP) address or Dynamic Name Service (DNS) name of the server where application service, for example verification composite service 90 is installed and running. With this facility available in the external network 79 system landscape, the gateway server 71 can do intelligent routing of HTTP requests coming from public internet 78.

In embodiments, the system may comprise one or more instances of each software service to carry out the embodiment. Each software service available in the system landscape may be virtualized using container based technology such that there will not be any port conflicts between different instances of application server running within the same server host. With all application service instances become available and registered with the discovery server, the gateway server 71 can intelligently route API requests at scale on demand basis using client side load balancer 74 to the appropriate application service, for example verification composite service 90.

In embodiments, the system may comprise one or more instances of verification composite service 90. This composite service 90 upon receiving request from gateway server 71 and with the information available from the discovery server 73, it sends the request to one or more instances of verification service 61 and app user service 63 respectively using a client load balancer 74 setup. The verification composite service 90 is also a discovery client 90A that gets automatically discovered by the service registration and discovery server 73.

In embodiments, the system may comprise at least one counterfeit database 64 to store detected counterfeited product information and its geographic locations. When the customer scans a product barcode data 50, the verification service 61 sends out a search query to the manufacturer network via external message gateway 68. The query request is then sent via internet 78 to manufacturer product database 66 via a firewall 67 for matching the information of the scanned product. If there is a match, the verification service 61 will receive product match information from manufacturer product database 66 and sends back to the customer's mobile device 51 and the information gets displayed on the mobile app 55 user interface. If there is no match, the verification service will mark it as a potential counterfeited product in a counterfeit database 64 and sends a signal back to the customer's mobile device 51 and displays, using the interface of the mobile app 55, indicating that the scanned product is a counterfeit.

If the embodiments described herein detect counterfeit products, the location of the counterfeit products may be obtained by modification of the embodiments such as tracking features. Such tracking features may include longitude and latitude coordinates (via GPS) at the time of scanning a desired product. The counterfeit information is stored in counterfeit database server 64.

In embodiments, the system may comprise at least one app user database server 65 to house the customer information. When the scanned product data 50 is sent to verification composite service 90, the app user specific information such as longitude, latitude of customer location, are also captured in app user database 65 through app user service 63. The verification composite service 90 makes use of available client side load balancing facility to send out search request to verification service 61 as well as send out app user information to update app user database 65. The app user database provides a powerful data intelligence platform for manufacturers to do precision marketing for their products.

At least one user database 65 runs on Linux, UNIX or Windows OS, MS SQL Server and may be fully patched and security updates installed. The app user database 65, counterfeit database 64 and coupon database 93 may comprise the qualities of high-availability and built-in redundancy. This information available in user database server may be used to perform tasks such as data analysis, storage, data manipulation, archiving and other marketing related tasks.

The coupon database 93 is used to account for tracking the issuance of discount coupons to customers who verifies the authenticity of the product that they are buying. A discount coupon functionality is an individualized feature that may become an additional leverage for the manufacturer in helping the customer buy the product at a discount price.

In embodiments, the system decrypts and separates the scanned barcode data 50 and user specific information, whereby the user information may be sent to app user service 63 and gets stored in user database 65. The user database 65 is a searchable and/or sortable. The decrypted barcode data may be sent to product database server 66 over encrypted Internet channel using HTTP and SSL 3.0 protocol via external message gateway 68 to the manufacturer network. The product database 66 contain the unique barcode data associated with each product manufactured by a given manufacturer or an entity, whereby a query may be run via verification service 61 against product database server 66 to determine if product database 66 contains the unique barcode data.

In embodiments, the verification composite service 90 sends back product verification information to the customer's mobile device 51. While sending the verification data, an individualized discount coupon 52, say for example 5% is also generated using coupon service 92 and sends it to customer's mobile phone 51 loaded with custom mobile scanning application 55. This individualized coupon mechanism is designed to motivate the customer 40 to make purchasing decisions. This individualized coupon may not be available to all customers and could be limited to selective users who scan the product barcode data 50 with their mobile device 51 loaded with scanning mobile app 55. The coupon service 92 is also a discovery client 92A that gets automatically discovered by the service registration and discovery server 73.

In embodiments, if the verification service 61 is unavailable for processing the verification request, the system will not invoke the coupon service 92 and sends a message back to the mobile user 40 to try the verification at a later time. To meet high customer demand, there may be at least two instances of coupon service 92 within the external network 79. The coupon reward information is maintained in its own database 93.

In embodiments, in order to protect sensitive data, all communication originating from the mobile device 51 to external network 79 are secured using industry standard Secure Sockets Layer (Transport Layer Security 3.0) protocol.

### Online Store Product Verification Flow

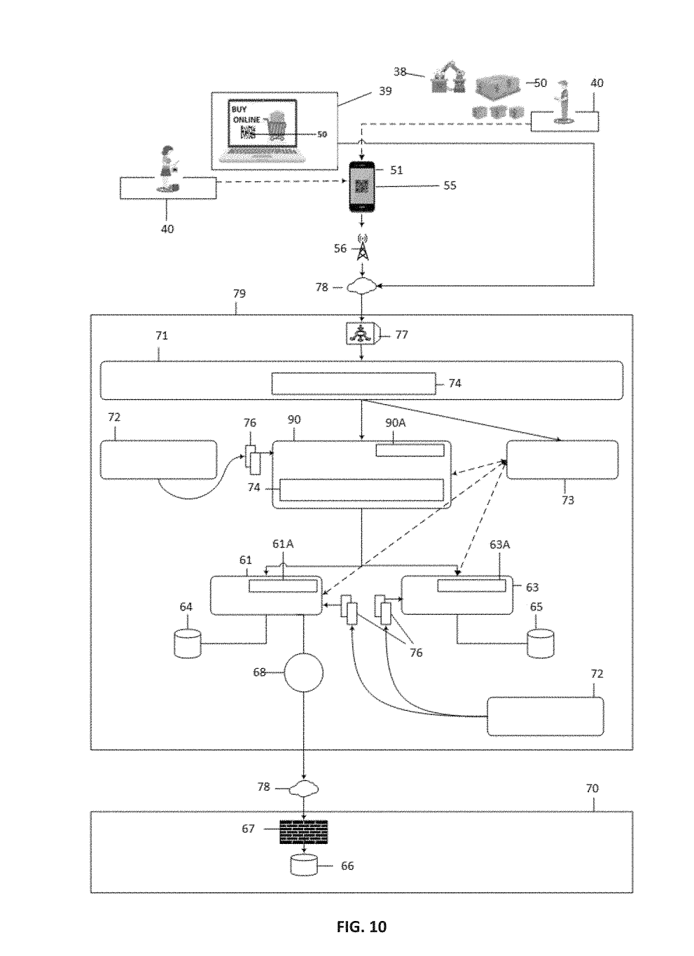

FIG. 10 shows an embodiment of a system, whereby a customer 40 can either scan a product barcode data 50 using a mobile device 51 loaded with a mobile scanning application 55 or when the customer 50 buys a product from an online storefront 39, the online store can initiate a product verification at the click of a button initiated by the customer 50 through their online store system. The scanning can also happen as and when the product reaches the online store warehouse 38 and the retailer can use their mobile device to scan the product authenticity just like a customer. The scanned barcode data 50 from the mobile device may be sent over internet 78 via telecommunication gateway 56 using hypertext transport protocol (HTTP) over encrypted channel using secured sockets layer 3.0 and transmitted to external network 79. If the verification happens via online storefront, the information gets sent via internet 78 to the external network 79 using hypertext transport protocol (HTTP) over an encrypted channel using secured sockets layer 3.0.

This external network 79 comprises a load balancer 77. External network 79 may also comprise one or more instances of a gateway server 71 that process intelligent routing of application programming interface (API) requests. This gateway server 71 may also have a capability to authenticate the incoming request via a standard protocol such as OAUTH2.

The external network 79 may also comprise a service registration and discovery server 73. This registration and discovery server 73 keeps track of all internal software services installed within the external network 79.

The gateway server 71 may use service registration and discovery server 73 to intelligently route HTTP requests sing a client side load balancer 74 by dynamically identifying the application server port and the server hostname internet protocol (IP) address or a Dynamic Name Service (DNS) name of the server where application service (for example verification composite service 90) is installed and running within the external network 79.

In embodiments, the system may comprise one or more instances of each software service to carry out the embodiment. Each software service available in the system landscape may be virtualized using container based technology such that there will not be any port conflicts between different instances of application server running within the same server host. With all application service instances become available and registered with the discovery server, the gateway server 71 can intelligently route Application Programming Interface (API) requests at scale on demand basis using client side load balancer 74 to the appropriate application service, for example verification composite service 90.

In embodiments, the system may comprise one or more instances of verification composite service 90. This verification composite service 90 upon receiving request from gateway server 71 and with the information available from the discovery server 73, sends the request to one or more instances of verification service 61 and app user service 63 respectively. The verification composite service 90 is also a discovery client 90A that gets automatically discovered by the service registration and discovery server 73.

In embodiments, the system may comprise at least one counterfeit database 64 to store scanned counterfeited product information and its geographic locations. When the customer scans a product barcode data 50, the verification service 61 sends out a search query to the manufacturer's network via external message gateway 68. The query request is then sent via internet 78 to manufacturer product database 66 via a firewall 67 for matching the scanned product. If there is a match, the verification service 61 will receive product match information from manufacturer's product database 66 which gets sent back to the customer mobile device 51 and the information gets displayed on the mobile device using the scanning app 55 user interface as a green check mark to indicate the product is genuine. The verification service 61 is also a discovery client 61A that gets automatically discovered by the service registration and discovery server 73.

If there is no match found, the verification service will mark it as a potential counterfeited product in counterfeit database 64 and display counterfeit information on the mobile device using the scanning app 55 user interface as a red mark.

If the embodiments described herein detect counterfeit products, the location of the counterfeit products may be obtained by modification of the embodiments to include tracking features. Such tracking features may include longitude and latitude coordinates via Global Positioning System (GPS) of the location where a product was scanned. Various stakeholders may be interested in knowing the origin or location of the point of sale for desired products determined to be counterfeit. The counterfeit information is stored in counterfeit database server 64. This counterfeit information can then be utilized by the product manufacturer for curbing the availability of counterfeited products in the market. By curbing the availability of counterfeited products, the manufacturer will ultimately benefit them financially and help preserve their brand image.

In embodiments, the system may comprise at least one app user database server 65 to house the customer information. When the scanned product data 50 is sent to verification composite service 90, the app user specific information such as longitude, latitude of customer location are also captured in app user database 65 through app user service 63. The verification composite service 90 makes use of available client side load balancing facility to send out search request to verification service 61 as well as sends out app user information to update app user database 65.

The at least one user database 65 is Linux, UNIX or Windows OS, or MS SQL Server and may be fully patched with security updates installed. The at least one app user database server 65 may comprise the qualities of high-availability and built-in redundancy. This information available in user database server may be used to perform tasks such as data analysis, storage, data manipulation, archiving and other marketing related tasks.

In embodiments, the system decrypts and separates the scanned barcode data 50 and user specific information, whereby the user information may be sent to app user service 63 and gets stored in user database 65. For marketing purposes this user database 65 may be searchable and/or sortable. The decrypted barcode data may be sent to product database server 66 over encrypted internet channel using HTTP and SSL 3.0 protocol via external message gateway 68 to the manufacturer network. The product database 66 contain the unique random barcode data associated with each product manufactured by a given company or entity, whereby a query may be run via verification service 61 against product database server 66 to determine if product database 66 contains the unique barcode data. The app user service 63 is also a discovery client 63A that gets automatically discovered by the service registration and discovery server 73.

In embodiments, the system may also comprise one or more instances of a configuration server 72. This configuration server will supply environment (development, staging or production) specific property values 76 to the appropriate application service that request for the same. This environment specific properties 76 may be available as name value pairs (application.service.name=Verification Service) in any commercially or open source available version control software.

It now be apparent that new, improved, and nonobvious systems have been described in this specification with sufficient particularity as to be understood by one of ordinary skill in the art. Moreover, it will be apparent to those skilled in the art that modifications, variations, substitutions, and equivalents exist for features of the systems which do not materially depart from the spirit and scope of the embodiments disclosed herein. Accordingly, it is expressly intended that all such modifications, variations, substitutions, and equivalents which fall within the spirit and scope of the invention as defined by the appended claims shall be embraced by the appended claims.

What is claimed is:

1. A system for determining a counterfeit product comprising:
a bar code data scanner and a product database server, wherein the bar code data scanner is adapted to communicate with the product database server, the product database server containing bar code data.

2. The system of claim 1, wherein the bar code data scanner is included in a mobile application on a mobile device, the mobile application adapted for at least one of scanning bar code data, encrypting the data, sending the encrypted data to the product database server, receiving information from the product database server which indicates whether the database server contains the scanned bar code data, providing mobile device location information, providing mobile device information and providing mobile device owner information.

3. The system of claim 2, including:
a first network comprising an application database server that accepts requests from the mobile application and is able to decrypt the encrypted data sent by the mobile application;
a first firewall allowing traffic from the Internet to the first network;
a second network comprising the product database server and optionally comprising a data storage database server; and
a second firewall allowing traffic from the application server to the product database and/or the optional data storage database server.

4. The system of claim 2, wherein the product database server is adapted for receiving, storing, searching and sorting bar code data, receiving at least one signal from the mobile application, sending at least one signal to the mobile application, tagging the scanned bar code data as scanned, and moving the scanned bar code data to a different file.

5. The system of claim 3, wherein the system includes the data storage database server, the data storage database adapted for receiving, storing, searching and sorting the mobile device location information, receiving, storing, searching and sorting the mobile device information and receiving, storing, searching and sorting the mobile device owner information.

6. The system of claim 2, wherein the second firewall is adapted to separate bar code data from the mobile device information and send the bar code data to the product database server and send the mobile device information to the data storage database server.

7. A method for determining a counterfeit product comprising:
assigning bar code data to a first product;
storing the bar code data of the first product to a product database server;
scanning with a mobile application bar code data of a second product in a marketplace;
sending the data associated with the scanned bar code data of the second product to the product database;
determining if the bar code data of the first product in the product database server matches the scanned bar code data of the second product in the marketplace.

8. The method of claim 7, including:
generating the bar code data for the first product;
encrypting the scanned bar code data of the second product;
decrypting the scanned bar code data of the second product; and
outputting a signal to the mobile application as to whether the bar code data of the first product in the product database server matches the scanned bar code data of the second product in the marketplace.

9. The method of claim 7, wherein sending the scanned bar code data of the second product to the product database server comprises sending the data over the internet.

10. The method of claim 8, wherein the outputting comprises binary information in the form of yes and no or in colors that correspond to yes and no.

11. The method of claim 1, wherein the bar code data of the first product is unique bar code data and/or randomly generated bar code data.
